(19) United States
(12) Patent Application Publication
(10) Pub. No.: US 2009/0239006 A1
(43) Pub. Date: Sep. 24, 2009

(54) AIR ENCLOSURE WITHOUT HEAT RESISTANT MATERIAL AND MANUFACTURING OF SAME

(76) Inventors: Chieh Hua LIAO, Taipei (TW); Yaw Shin Liao, Taipei (TW); Yao Chuan Liao, Taipei (TW)

Correspondence Address: BIRCH STEWART KOLASCH & BIRCH, PO BOX 747, FALLS CHURCH, VA, 22040-0747, US

(21) Appl. No.: 12/334,342

(22) Filed: Dec. 12, 2008

(30) Foreign Application Priority Data
Mar. 21, 2008 (TW) 97110269

(51) Int. Cl. B32B 1/08; B29C 65/00

(52) U.S. Cl. 428/34.1; 156/287

(57) ABSTRACT

An air enclosure without a heat resistant material is formed by stacking two outer films and two inner films, allowing the two inner films to be lain in between the two outer films, placing a heat resistant pad between the two inner films, adhering the two outer films and the two inner films to each other to form at least one air inlet between the two inner films and at least one air cylinder between the two outer films, and thereafter, taking out the heat resistant pad, and filling air into the air cylinder via the air inlet to cause the air cylinder to be filled with air and expanded, where the air in the air cylinder compresses the two inner films to cover the air inlet to shield the air cylinder.

### CROSS-REFERENCES TO RELATED APPLICATIONS

This non-provisional application claims priority under 35 U.S.C. §119(a) on Patent Application No(s). 97110269 filed in Taiwan, R.O.C. on Mar. 21, 2008, the entire contents of which are hereby incorporated by reference.

### FIELD OF THE INVENTION

The present invention relates to an air enclosure and a method for manufacturing it, and more particularly to an air enclosure without a heat resistant material and a method for manufacturing it.

### BACKGROUND

Generally, when an article is packed, a soft material such as foam or Styrofoam is used to provide the article with a cushioning protection. However, foam can be attached closely to a surface of the article, but mere impact protection is sub-optimal; the article is still frequently struck and damaged. Moreover, foam is difficult to deal with; it is accompanied by environmental protection issues. The Styrofoam may prevent an article from being damaged by shaking, but a bouffant volume of Styrofoam occupies a large volume, does not decompose easy, and will release poisonous gas after incineration, causing serious environmental pollution. Thus foam and Styrofoam cause environmental protection problems; Styrofoam is not an ideal cushioning material in the current culture of heightened environmental consciousness.

To solve the aforementioned problems, an air enclosure using a resin film as a material is developed; it is sealed by means of hot sealing to form an air cylinder and disposed with an air filling entrance. The air enclosure can be used as a cushioning material during an inner packing after being filled in the air cylinder via the air filling entrance, where a check valve will be disposed in the air enclosure to create an air lock.

Please refer to FIGS. 1A to 1C. FIGS. 1A to 1C show an assembly structure of a shut-off valve of an air enclosure, and an apparatus for manufacturing an air enclosure with a switching valve disclosed by Taiwan Patent No. 587049. While a check valve is formed by means of hot sealing, a side bag sheet A11 and valve sheets A21 and A22 are first stacked together, and then formed with a plurality of fixing sealing portions A31 by means of hot sealing, thereby adhering the side bag sheet A11 and the two valve sheets A21 and A22 together by means of hot sealing as FIG. 1A shows; furthermore, another side bag sheet A12 is then stacked with them, front and rear sealing portions A4 and a strengthening sealing portions A32 are formed by adhering them all together by means of hot sealing, and an air inlet A6 is formed between the two strengthening sealing portions A32 as FIG. 1B shows; finally, left and right sealing portions A5 are formed by means of hot sealing, and air cylinders A8 are formed among the front and rear sealing portions A4 and the left and right sealing portions A5 as well as an air filling entrance A7 is formed among one side of the strengthening sealing portions A32 and the right and left sealing portions A5 as FIG. 1C shows. Air in the fill passageway A7 can then be moved into the air cylinders A8 via the air inlets A6. The bag sheets A11 and A22 are caused to pull apart outward after air flows into the air filling passageway A7, but the two valve sheets will be moved with the bag sheet A11 owing to the adhering of the three layers of the bag sheet A11 and the two sheets of valve sheet A21, A22 such that the air inlet A6 cannot be pulled apart outward with the bag sheets A11, A12 to open; this causes the air to stay in the air filling passageway A7, further compressing the two valve sheets A21, A22 attaching to the bag sheet A11 to shield the air inlet A6 closely and prevent air from entering the air cylinder A8 via the air inlet A6.

Please refer to FIGS. 2A and 2B. FIGS. 2A and 2B show a continuously air-filling air enclosure disclosed by Taiwan Patent No. M306977. A heat resistant material B10 is spread between two sheets of inner film B11 and B12 in advance, and the two sheets of inner film B11 and B12 are then stacked together between two sheets of outer film B21 and B22; hot sealing is carried out along hot sealing lines B3 and B4 to allow the two sheets of outer film B21 and B22 to be adhered to each other to form an air filling passageway B9 and air inlets B14 at places of the hot sealing line B4 spread with the heat resistant material B10, and hot sealing is carried out along hot sealing lines B4, B5, B6 and B7 to allow the two sheets of outer film B21 and B22 to be adhered to each other to form an air cylinder B8. This method may solve the problem in the aforementioned invention patent of being unable to open the air inlet, but the heat resistant material must be spread between the two sheets of inner film in advance and the two sheets of inner film can then be stacked together. Hence, not only the material cost is increased but the process of spreading the heat resistant material is time and labor wasting; this prevents the effective reduction of the production cost of an air enclosure.

### SUMMARY OF THE INVENTION

To improve an air inlet of an air enclosure and its manufacturing process, decreasing the labor and the material costs consumed by spreading a heat resistant material and in the meantime, allowing the air inlet to be opened effectively so as to enable the air filling to be continuous to save the air filling time, the present invention is proposed.

To achieve the objects mentioned above, the present invention proposes an air enclosure without a hear resistant material, including:
two outer films, stacked together vertically;
two inner films, positioned between the two outer films;
at least one air cylinder, formed between the two outer films by means of hot sealing; and
at least one air inlet, formed between the two inner films by adhering the two outer films and the two inner films together by means of hot sealing after placing a heat resistant pad between the two inner films thereby allowing air to be filled in the air cylinder via the air inlet to cause the air cylinder to be filled with air and expanded to enable air in the air cylinder to compress the two inner films to cover the air inlet to shield the air cylinder.

The present invention also proposes a method for manufacturing an air enclosure without a heat resistant material, including the following steps:
providing two inner films;
stacking two outer films together to allow the two inner films to be lain in between the two outer films;
placing at least one heat resistant pad between the two inner films;
adhering the two outer films to the two inner films by means of hot sealing to form at least one air inlet between the two inner films and at least one air cylinder between the two outer films;
taking out the heat resistant pad;
filling air into the air cylinder via the air inlet to allow the air cylinder to be filled with air and expanded; and
using air in the air cylinder to compress the two inner films to cover the air inlet to shield the air cylinder.

Where it is not necessary to spread a heat resistant material in advance according to the present invention, the two sheets of inner film are stacked together directly and the heat resistant pad is used to place in between the two inner films to form the air inlet by means of hot sealing thereby shortening the manufacturing process effectively and reducing the labor and the material costs substantially. In addition, when the two sheets of outer film are pulled apart, the air inlets formed by the inner films are opened automatically, air is filled into the plurality of air cylinders via the air inlets; it is unnecessary to position each air inlet while being filled with air, thus reducing the air filling time. Each air cylinder is independent and the cushioning effect is not influenced even if some air cylinders are broken. The air in the air cylinder compresses the inner films to cover the air inlet to shield the air cylinder creating an air lock.

### BRIEF DESCRIPTION OF THE DRAWINGS

The present invention can be more fully understood by reference to the following description and accompanying drawings, in which:

FIGS. 1A to 1C are schematic views of a conventional check valve while being manufactured;

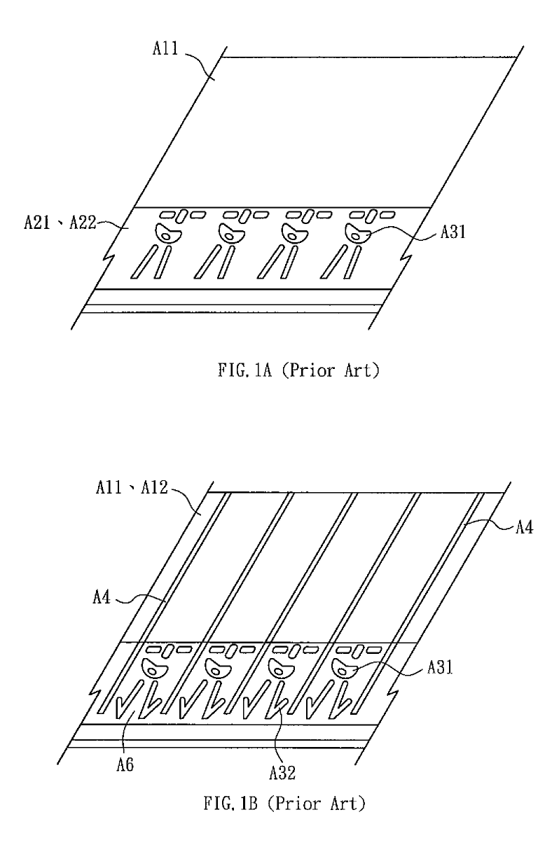

FIG. 2A is a cross sectional view of a conventional air enclosure;

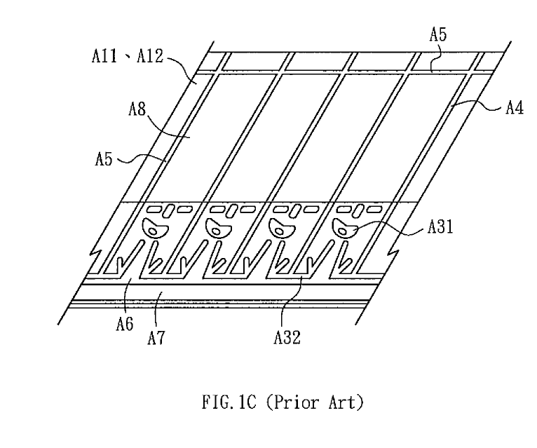

FIG. 2B is a plane view of a conventional air enclosure;

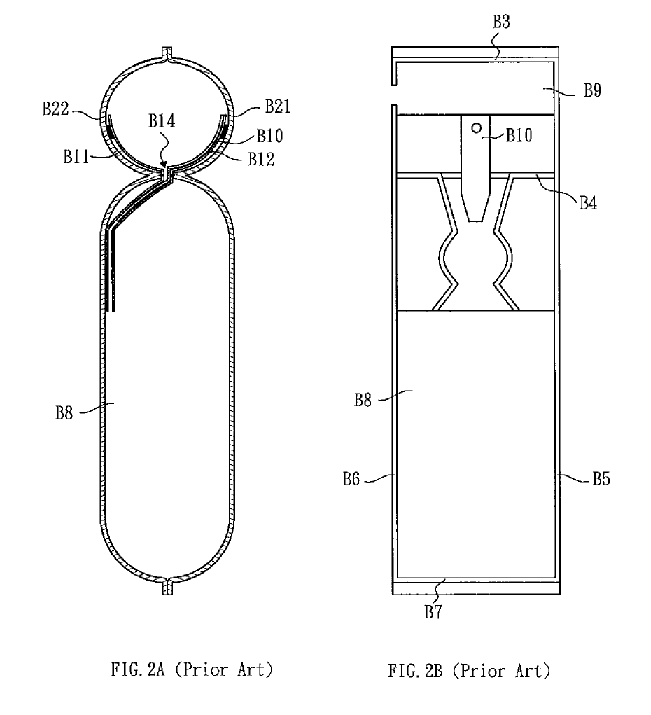

FIG. 3 is a perspective view, showing an air enclosure of a first embodiment according to the present invention after being filled with air;

FIG. 4 is a schematic view, showing an air enclosure of the first embodiment according to the present invention while being manufactured by inserting a heat resistant pad;

FIG. 5 is a plane view, showing an air enclosure of the first embodiment according to the present invention after being filled with air;

FIG. 6A is a schematic view, showing a heat resistant pad of the first embodiment according to the present invention while being manufactured;

FIG. 6B is a plane view, showing an air enclosure of the first embodiment according to the present invention before being filled with air;

FIGS. 7A and 7B are cross sectional views, showing an air enclosure of the first embodiment while being manufactured by inserting a heat resistant pad;

FIGS. 8A and 8B are schematic views, showing an air enclosure of a second embodiment while being manufactured by inserting a heat resistant pad;

FIG. 9 is a cross sectional view, showing an air enclosure of the second embodiment according to the present invention after being filled with air;

FIG. 10 is a plane view, showing an air enclosure of a third embodiment according to the present invention before being filled with air; and

FIGS. 11 and 12 are cross sectional views, showing an air enclosure of the third embodiment according to the present invention after being filled with air.

### DETAILED DESCRIPTION OF THE PREFERRED EMBODIMENTS

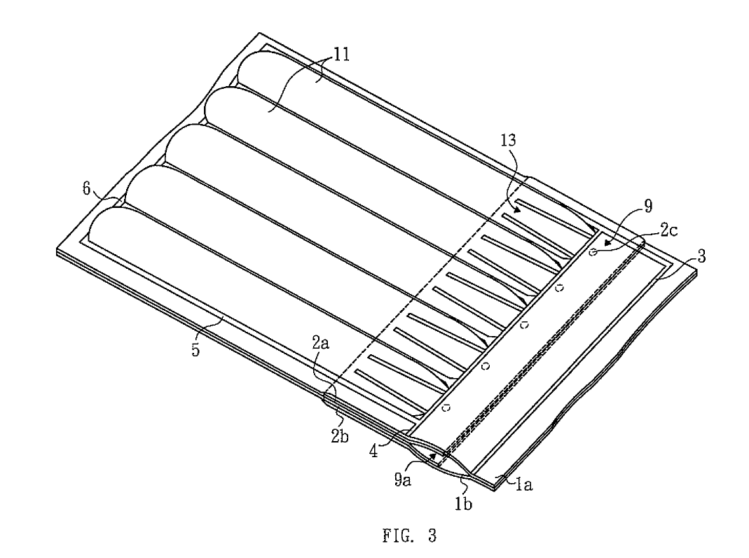

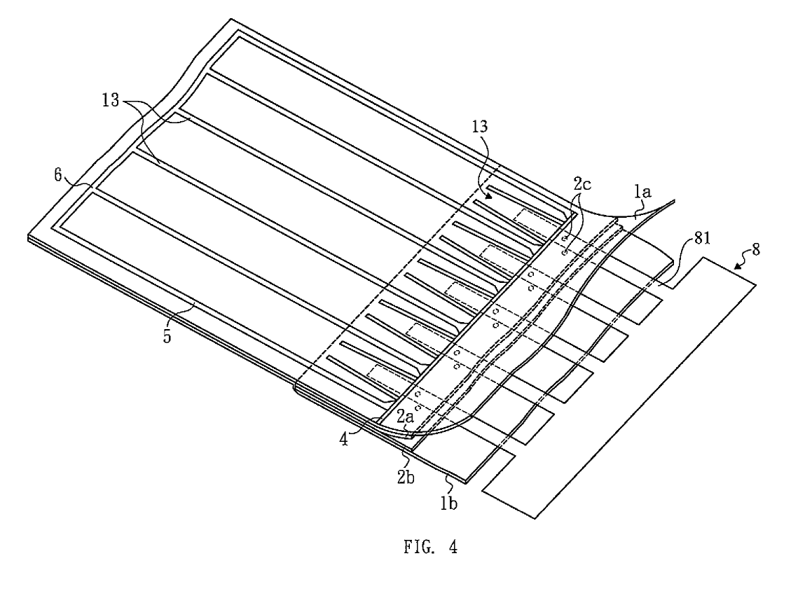

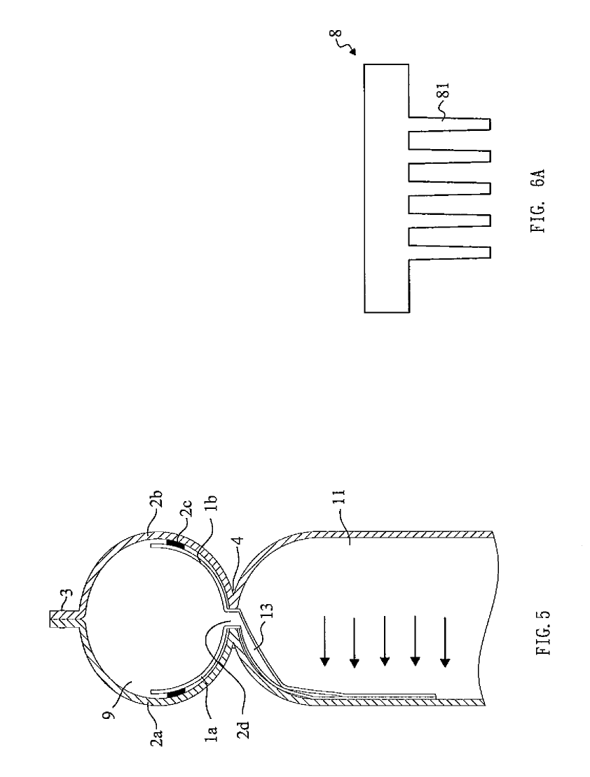

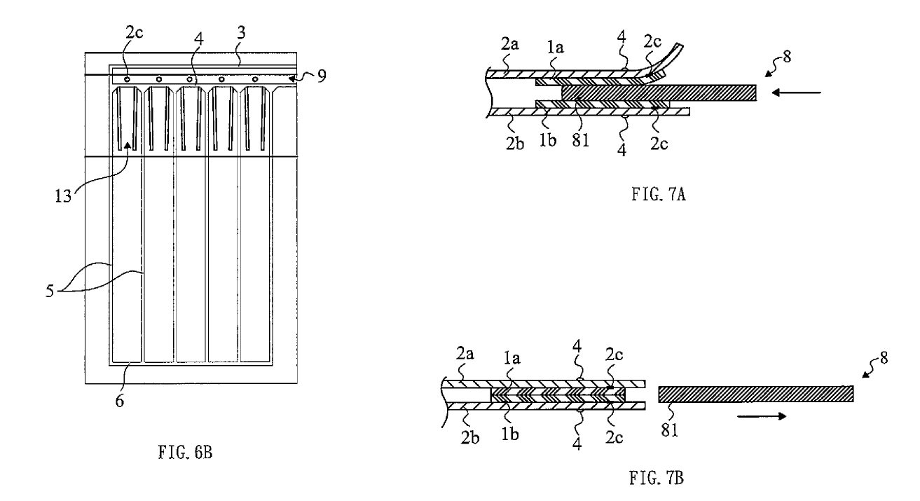

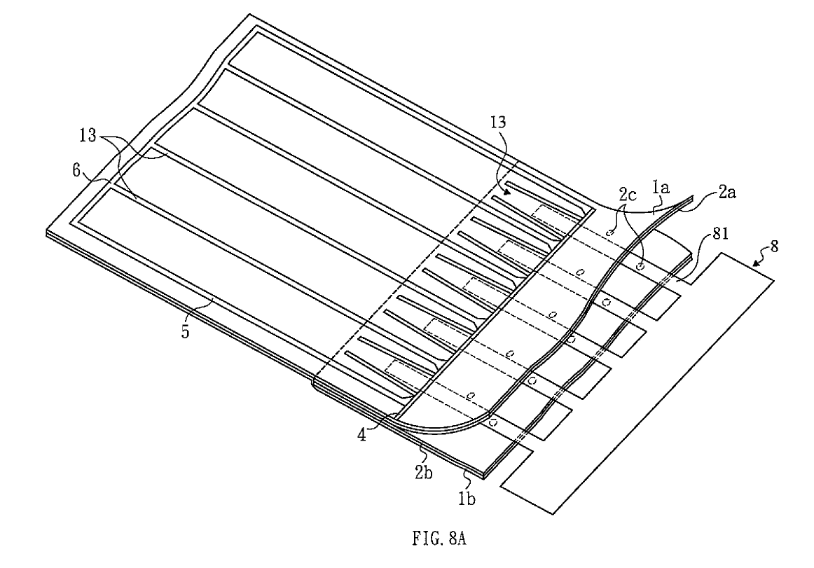

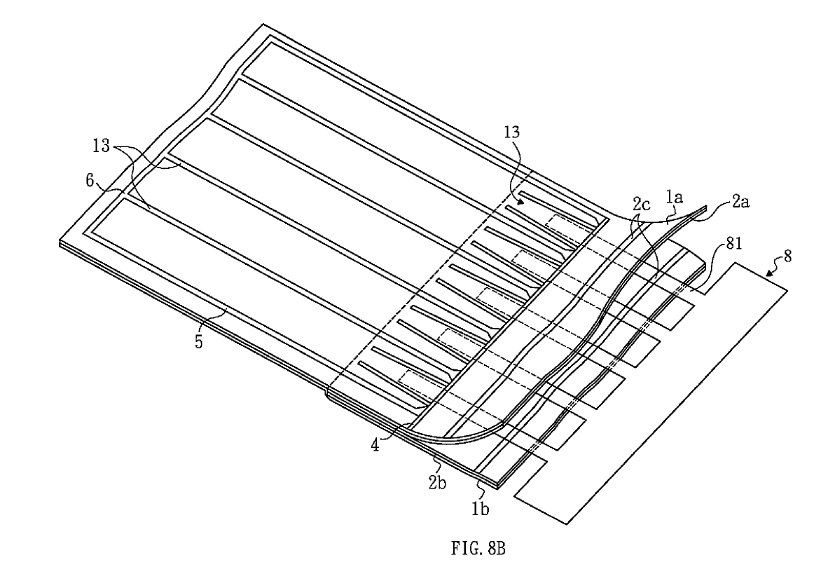

Please refer to FIGS. 3, 4, 5, 6A, 6B, 7A and 7B. FIG. 3 is a perspective view, showing an air enclosure of a first embodiment according to the present invention after being filled with air. FIG. 4 is a schematic view, showing an air enclosure of the first embodiment according to the present invention while being manufactured by inserting a heat resistant pad. FIG. 5 is a plane view, showing an air enclosure of the first embodiment according to the present invention after being filled with air. FIG. 6A is a schematic view, showing a heat resistant pad of the first embodiment according to the present invention while being manufactured. FIG. 6B is a plane view, showing an air enclosure of the first embodiment according to the present invention before being filled with air. FIGS. 7A and 7B are cross sectional views, showing an air enclosure of the first embodiment while being manufactured by inserting a heat resistant pad.

An air enclosure without a heat resistant material includes two sheets of outer film 2a and 2b, two sheets of inner film 1a and 1b, an air filling passageway 9, a plurality of air cylinders 11 and a plurality of air inlets 2d.

The two sheets of outer film 2a and 2b are stacked together vertically.

The two sheets of inner film 1a and 1b are lain in between the two sheets of outer film 2a and 2b, lengths of the inner films 1a and 1b are shorter than a length of the outer film 2a or 2b, and top ends of the two sheets of inner film are lower than top ends of the two sheets of outer film 2a and 2b.

A heat resistant pad 8 is placed between the two sheets of inner film 1a and 1b; hot sealing is carried out along a hot sealing line 4, the two sheets of inner film 1a and 1b are still not adhered to each other to form a plurality of air inlet 2d and in the meantime, hot sealing is used to generate a plurality of hot sealing portions 2c thereby adhering the outer 2a to the inner film 1a and the outer film 2b to the inner film 1b, where the heat resistant pad 9 is disposed with a plurality of projecting portions 81. The plurality of projecting portions 81 of the heat resistant pad 8 are placed between the two sheets of inner film 1a and 1b, and the two sheets of outer film 2a and 2b and the two sheets of inner film 1a and 1b are adhered to each other by means of hot sealing along the hot sealing line 4 to form the plurality of air inlets 2d.

Hot sealing is carried out along a hot sealing line 3 to allow the two sheets of outer film 2a and 2b to be adhered to each other to form an air filling passageway 9 between the hot sealing lines 3 and 4, where the air filling passageway 9 includes an air filling entrance 9a connected to the outside; hot sealing is carried out along hot sealing lines 5 and 6 to allow the two sheets of outer film 2a and 2b to be adhered to each other to form a plurality of air cylinders 11 among the hot sealing lines 4, 5 and 6, where the air cylinder 11 is used for storing air, and the air inlet 2d communicates the air cylinder 11 with the air filling passageway 9.

Air entering the air filling entrance 9a expands the air filling passageway 9 to cause the two sheets of outer film 2a and 2b to be pulled apart outward, and the two sheets of inner film 1a and 1b can be pushed apart by the hot sealing portions 2c positioned in the air filling passageway 9 to open outward because the outer film 2a and the inner film 1a together with the outer film 2b and the inner film 1b are adhered to each other by means of hot sealing thereby allowing the two sheets of inner film 1a and 1b not adhered to each other to be pull apart outward to automatically open each air inlet 2d connected to the air filling passageway 9, as FIG. 5 shows. The air in the air filling passageway 9 can be filled into each air cylinder 11 to cause it to expand via each air inlet 2d; it is unnecessary to carry out the air filling after positioning each air inlet 2d, thus reducing air filling time; further, the entire cushioning effect is not influenced even if some air cylinders 11 are broken because each air cylinder is independent.

After air enters the air cylinder 11 via the air inlet 2d, internal air pressure of the air cylinder 11 compresses the inner film 1a or 1b to cover the air inlet 2d and shield the air cylinder 11 so as to create an air lock.

A gradually contracted air passageway 13 connected to the air inlet 2d may be disposed in advance in the air cylinder 11. One end of the air passageway 13 connected with the air inlet 2d is wider than another end thereof to allow the air in the air inlet 2d to enter easily but not escape easily. In addition, a curved air passageway 13 connected with the air inlet 2d may also be disposed in advance in the air cylinder 11. A curved portion of the air passageway 13 is compressed tightly to create an air lock while the internal pressure of the air cylinder 11 increases.

In addition, if the inner film 1a and the outer film 2a are adhered to each other by means of hot sealing, the two sheets of inner film 1a and 1b are side-attached to the outer film 2a while being compressed as FIG. 5 show; if the inner film 1b and the outer film 2b are adhered to each other by means of hot sealing, the two sheets of inner film 1a and 1b are side-attached to the outer film 2b while being compressed. Such an air enclosure where the two sheets of inner film 1a and 1b are compressed by the air in the air cylinder 11 to side-attach onto the outer film 2a or 2b is referred to as a “two sheets side-attachment type” air enclosure. Furthermore, the air enclosure where the two sheets of inner film are not side-attached to the outer film 2a or 2b but suspended in the air cylinder 11 while being compressed is referred to as a “two sheets wall-hanging type” air enclosure.

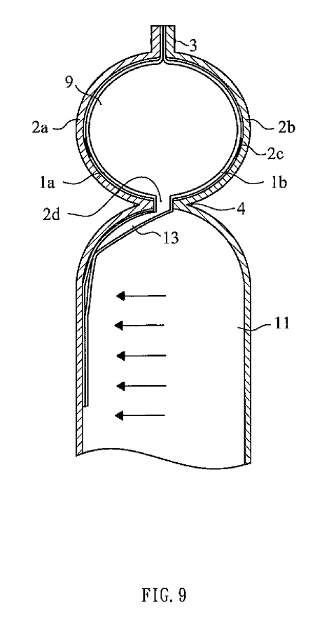

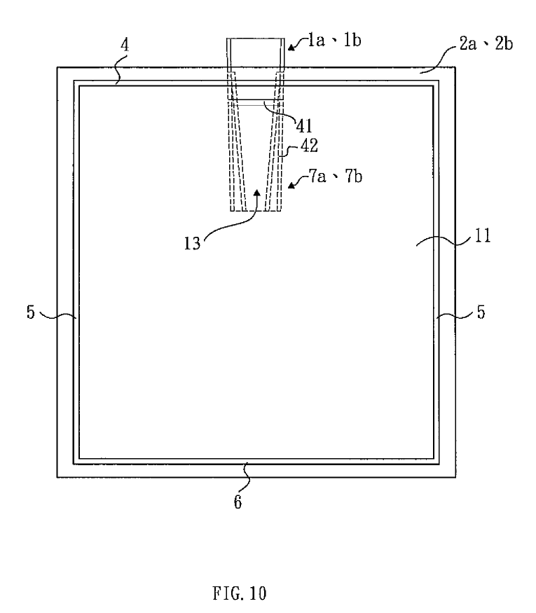

Please refer to FIGS. 8A, 8B and 9. FIGS. 8A and 8B are schematic views, showing an air enclosure of a second embodiment while being manufactured by inserting a heat resistant pad. FIG. 9 is a cross sectional view, showing an air enclosure of the second embodiment according to the present invention after being filled with air.

In the present embodiment, top ends of the two sheets of inner film 1a and 1b are aligned with top ends of the two sheets of outer film 2a and 2b, and hot sealing is used to generate hot sealing portions 2c thereby adhering the outer film 2a to the inner film 1a and the outer film 2b to the inner film 1b, where the hot sealing portions 2c may be a plurality of hot sealing points as FIG. 8A shows, or may be a plurality of hot sealing lines as FIG. 8B shows, but it is not limited to these.

Furthermore, when the hot sealing is carried out along the hot sealing line 3, the two sheets of inner film 1a and 1b are adhered to each other to form an air filling passageway 9 between the hot sealing lines 3 and 4. When the air filling passageway 9 is filled with air and expanded, it will drive the two sheets of inner film 1a and 1b to pull apart outward to automatically open each air inlet 2d connected with the air filling passageway 9 to allow the air in the air filling passageway 9 to be filled into each air cylinder 11 to cause it to be filled with air and expanded via each air inlet 2d.

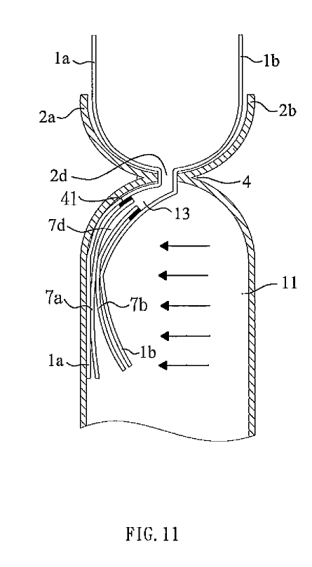

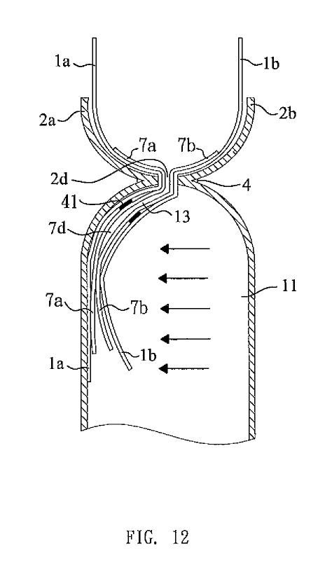

Please refer to FIGS. 10, 11 and 12. FIG. 10 is a plane view, showing an air enclosure of a third embodiment according to the present invention before being filled with air. FIGS. 11 and 12 are cross sectional views, showing an air enclosure of the third embodiment according to the present invention after being filled with air.

The present invention may further includes two sheets of auxiliary film 7a and 7b positioned between the two sheets of inner film 1a and 1b. Two sides of the two sheets of inner film 1a and 1b and two sides of the auxiliary film 7a and 7b are adhered to each other by means of hot sealing along an auxiliary hot sealing line 42, and the projecting portions 81 of the heat resistant pad 8 are then placed between the two sheets of auxiliary film 7a and 7b. Thereafter, the two sheets of inner film 1a and 1b together with the two sheets of auxiliary films 7a and 7b are adhered to each other by means of hot sealing along a hot sealing line 41 to form a plurality of auxiliary air inlet 7d between the two sheets of auxiliary film 7a and 7b.

Wherein, the two sheets of auxiliary film 7a and 7b are disposed at a bottom place between the two sheets of inner film 1a and 1b, i.e. a position below the hot sealing line 4 as FIG. 11 shows; they may also disposed at a middle position between the two sheets of inner film 1a and 1b, i.e. parts of the auxiliary films 7a and 7b are positioned above the hot sealing line 4, and other parts thereof are positioned below the hot sealing line 4 as FIG. 12 shows.

Where the air filling passageway 9 is not disposed in the present embodiment, a user may directly and manually pull the two sheets of inner film 1a and 1b apart outward and in the meantime, the two sheets of auxiliary film 7a and 7b not adhered to each other are caused to pull apart outward to automatically open the auxiliary air inlet 7d, and an air filling tool (not shown in the figure) is then used to do the air filling. Thereafter, air can be filled in each air cylinder 11 via the air inlet 2d and the auxiliary air inlet 7d.

Although the present embodiment assumes for the sake of example that the side of the air cylinder 11 is not disposed with the air filling passageway 9, it is not limited to this. The structure may be adjusted depending on practical requirements. For example, the two sheets of outer film 2a and 2b are adhered to each other or the two sheets of inner film 1a and 1b to each other by means of hot sealing to form the air filling passageway 9; air entering the air filling entrance 9a expands the air filling passageway 9 to cause the two sheets of outer film 2a and 2b to be pulled apart outward. Because the outer film 2a and the inner film 1a as well as the outer film 2b and the inner film 1b are adhered to each other by means of hot sealing, the two sheets of inner film 1a and 1b can be driven to open outward through the hot sealing portion 2c positioned in the air filling passageway 9 thereby allowing the two sheets of inner film 1a and 1b not adhered to each other to be pulled apart outward to automatically open each air inlet 2d connected with the air filling passageway 9 and in the meantime, allowing the two sheets of auxiliary film 7a and 7b not adhered to each other to be pulled apart outward to automatically open the auxiliary air inlet 7d. The air in the air filling passageway 9 can be filled in each air cylinder 11 to cause it to be filled with air and expanded via the air inlet 2d and the auxiliary air inlet 7d.

In the present embodiment, the two sheets of auxiliary film 7a and 7b are further disposed between the two sheets of inner film 1a and 1b thereby allowing high pressure air to be filled in the air cylinder 11 to prevent high pressure air from causing the two sheets of inner film 1a and 1b to be broken during the air filling to increase air filling efficiency.

A method for manufacturing an air enclosure without a heat resistant material according to the present invention, includes the following steps:

Step 1: providing two sheets of inner film 1a and 1b;

Step 2: stacking two sheets of outer film 2a and 2b to allow the two sheets of inner film 1a and 1b to be lain in between the two sheets of outer film 2a and 2b;

Lengths of the two sheets of inner film 1a and 1b are shorter than lengths of the two sheets of outer film 2a and 2b, and top ends of the two sheets of inner 1a and 1b are lower than top ends of the two sheets of outer film 2a and 2b, or aligned with the top ends of the two sheets of outer film 2a and 2b.

Step 3: placing a heat resistant pad 8 between the two sheets of inner film 1a and 1b;

The heat resistant pad 8 is disposed with a plurality of projecting portions 81, and the plurality of projecting portions 81 of the heat resistant pad 8 are placed between the two sheets of inner film 1a and 1b.

Step 4: adhering the two sheets of outer film 2a and 2b and the two sheets of inner film 1a and 1b to each other by means of hot sealing to form a plurality of air inlets 2d and form a plurality of air cylinders 11 between the two sheets of outer film 2a and 2b.

When the top ends of the two sheets of inner film 1a and 1b are lower than the top ends of the two sheets of outer film 2a and 2b, the two sheets of outer film 2a and 2b as well as the two sheets of inner film 1a and 1b adhered to each other by means of hot sealing along a hot sealing line 4 to form a plurality of air inlets 2d and in the meantime, generate a hot sealing portion 2c by means of hot sealing, thereby adhering the outer film 2a to the inner film 1a and the outer film 2b to the inner film 1b; the two sheets of outer film 2a and 2b are adhered to each other by means of hot sealing along a hot sealing line 3 to form an air filling passageway 9 between the hot sealing lines 3 and 4, and the air filling passageway 9 includes an air filling entrance 9a connected to the outside.

When the top ends of the two sheets of inner film 1a and 1b are aligned with the top ends of the two sheets of outer film 2a and 2b, hot sealing portions 2c are generated by means of hot sealing thereby adhering the outer film 2a to the inner film 1a and the outer film 2b to the inner film 1b, where the hot sealing portions 2c may be a plurality of hot sealing points or hot sealing lines. The two sheets of outer film 2a and 2b as well as the two sheets of inner film 1a and 1b are adhered to each other by means of hot sealing along a hot sealing line 4 to form a plurality of air inlets 2d; the two sheets of inner film 1a and 1b are adhered to each other by process hot sealing along a hot sealing line 3 to form an air filling entrance 9 between the hot sealing lines 3 and 4, and the air filling passageway 9 includes an air filling entrance 9a connected to the outside.

Hot sealing is carried out along hot sealing lines 5 and 6 to allow the two sheets of outer film 2a and 2b to be adhered to each other to form air cylinders 11 among the hot sealing lines 4, 5 and 6, the air cylinder 11 is used for storing air, and the air inlet 2d communicates the air cylinder 11 with the air filling passageway 9. In addition, the air filling passageway 9 is positioned at one side of the air cylinder 11.

Step 5: taking out the heat resistant pad 8;

Step 6: filling air into the air cylinder 11 via the air inlet 2d to allow the air cylinder 11 to be filled with air and expanded.

When the air filling passageway 9 is formed by adhering the two sheets of outer film 2a and 2b, air entering the air filling entrance 9a expands the air filling passageway 9 to cause the two sheets of outer film 2a and 2b to be pulled apart outward. Because the outer film 2a and the inner film 1a as well as the outer film 2b and the inner film 1b are adhered to each other by means of hot sealing, the two sheets of inner film 1a and 1b can be pushed open outward through the hot sealing portion 2c positioned in the air filling passageway 9, thereby allowing the two sheets of inner film 1a and 1b not adhered to each other to be pulled apart outward to automatically open each air inlet 2d connected with the air filling passageway 9. The air in the air filling passageway 9 can be filled in each air cylinder 11 via each air inlet 2d to cause the air cylinder 11 to be filled with air and expanded. If the air cylinder passageway 9 is formed by adhering the two sheets of inner film 1a and 1b to each other, air entering the air filling entrance 9a expands the air filling passageway 9 to drive the two sheets of inner film 1a and 1b to pull apart outward to automatically open each air inlet 2d connected to the air filling entrance 9 to allow the air in the air filling passageway 9 to be filled in each cylinder 11 via each air inlet 2d to cause the air cylinder to be filled with air and expanded.

Step 7: using the air in the air cylinder 11 to compress the two sheets of inner film 1a and 1b to cover the air inlet 2d and shield the air cylinder 11.

After air enters the air cylinder 11 via the air inlet 2d, internal air pressure of the air cylinder 11 compresses the inner film 1a or 1b to cover the air inlet 2d and shield the air cylinder 11 so as to create an air lock. In this case, when the two sheets of inner film 1a and 1b are compressed they can be side-attached to the one sheet of outer film 2a or 2b, or not be side-attached to the outer film 2a or 2b but suspended in the air cylinder 11.

Furthermore, the method according to the present invention may further include after Step 1: providing two sheets of auxiliary film 7a and 7b to allow the two sheets of auxiliary film 7a and 7b to be lain in between the two sheets of inner film 1a and 1b. Therefore, two sides of the two sheets of inner film 1a and 1b and two sides of the two sheets of auxiliary film 7a and 7b are adhered to each other in advance by means of hot sealing along an auxiliary hot sealing line 42 in Step 2, and the plurality of projecting portions 81 of the heat resistant pad 8 are then placed between the two sheets of auxiliary film 7a and 7b. The two sheets of inner film 1a and 1b as well as the two sheets of auxiliary film 7a and 7b are adhered to each other by means of hot sealing along an auxiliary hot sealing line 41 to form a plurality of auxiliary air inlets 7d between the two sheets of auxiliary film 7a and 7b. In this case, the two sheets of auxiliary film 7a and 7b are disposed at a bottom place between the two sheets of inner film 1a and 1b, i.e. a position below the hot sealing line 4; they may also be disposed at a middle position between the two sheets of inner film 1a and 1b, i.e. parts of the auxiliary films 7a and 7b are positioned above the hot sealing line 4, and other parts thereof are positioned below the hot sealing line 4.

According to the present invention, the two sheets of inner film are stacked together directly, it is unnecessary to spread in advance a heat resistant material between the two sheets of inner film, a heat resistant pad is placed between the two sheets of inner film and hot sealing is carried out to adhere the two sheets of inner film to each other to form air inlets so as to shorten effectively the manufacturing process and reduce substantially labor and material costs. In addition, according to the present invention, the air inlets can be opened automatically while the air filling is being processed so as to fill the plurality of air cylinders with air via the air inlets; it is not necessary to position each air inlet during the air filling, thus reducing air filling time. Each air cylinder is independent; the cushioning effect is not influenced even if some air cylinders are broken. The air in the air cylinder compresses the inner films to cover the air inlet to shield the air cylinder; the air can be prevented from leaking to attain to the air locking effect. Moreover, the air compresses the curved portion of the air passageway when the internal air pressure of the air cylinder increases to attain to the air locking effect too.

Additional advantages and modifications will readily occur to those skilled in the art. Therefore, the invention in its broader aspects is not limited to the specific details and representative embodiments shown and described herein. Accordingly, various modifications may be made without departing from the scope of the general inventive concept as defined by the appended claims and their equivalents.

What is claimed is:

1. An air enclosure without a heat resistant material, comprising:
two outer films, stacked together vertically;
two inner films, positioned between the two outer films;
at least one air cylinder, formed between the two outer films by adhering the two outer films to each other by means of hot sealing; and
at least one air inlet, formed between the two inner films by placing a heat resistant pad between the two inner films and allowing the two outer films and the two inner films to be adhered to each other by means of hot sealing, air being filled into the air cylinder via the air inlet to cause the air cylinder to be filled with air and expanded, air in the air cylinder compressing the two inner film to cover the air inlet to shield the air cylinder.

2. The air enclosure without a heat resistant material according to claim 1, wherein the two inner films are not side-attached to the two outer films but suspended in the air cylinder while being compressed.

3. The air enclosure without a heat resistant material according to claim 1, wherein one of the two inner films and one of the two outer films are adhered to each other by means of hot sealing, the two inner films are side-attached to one of the two outer films while being compressed.

4. The air enclosure without a heat resistant material according to claim 1, wherein the heat resistant pad comprises a plurality of projecting portions, the projecting portions are placed between the two inner films, the two outer films and the two inner films are adhered to each other by means of hot sealing to form the plurality of air inlets.

5. The air enclosure without a heat resistant material according to claim 1, further comprising an air filling passageway positioned at one side of the air cylinder, the air inlet communicating the air cylinder with the air filling passageway.

6. The air enclosure without a heat resistant material according to claim 5, wherein the air filling passageway is formed by adhering the two outer films to each other by means of hot sealing.

7. The air enclosure without a heat resistant material according to claim 6, further comprising a plurality of hot sealing portion positioned in the air filling passageway, respectively adhering one sheet of the outer film to the one sheet of the inner film, the two inner films are driven by the hot sealing portions to pull apart outward to open the air inlet to allow air in the air filling passageway to be filled into the air cylinder when the two outer films are pulled apart outward.

8. The air enclosure without a heat resistant material according to claim 5, wherein the air filling passageway is formed by adhering the two inner films to each other by means of hot sealing, the two inner films are pulled apart outward to open the air inlet to allow air in the air filling passageway to be filled into the air cylinder when the air filling passageway is filled with air and expanded.

9. The air enclosure without a heat resistant material according to claim 1, further comprising two auxiliary films positioned between the two inner films.

10. The air enclosure without a heat resistant material according to claim 9, further comprising at least one auxiliary air inlet, formed between the two auxiliary films by placing the heat resistant pad between the two auxiliary films and at least adhering the two inner films and the two auxiliary films to each other by means of hot sealing.

11. A method for manufacturing an air enclosure without a heat resistant material, comprising the following steps:
providing two inner films;
stacking two outer films to allow the two inner films to be lain in between the two outer films;
placing a heat resistant pad between the two inner films;
adhering the tow outer films and the two inner films to each other by hot sealing to form at least one air inlet between the two inner films and at least one air cylinder between the two outer films;
taking out the heat resistant pad;
filling air into the air cylinder to cause the air cylinder to be filled with air and expanded via the air inlet; and
using the air in the air cylinder to compress the two inner films to cover the air inlet to shield the air cylinder.

12. The method for manufacturing an air enclosure without a heat resistant material according to claim 11, wherein the two inner films are not side-attached to the two outer films but hung in the air cylinder while being compressed.

13. The method for manufacturing an air enclosure without a heat resistant material according to claim 11, wherein one of the two inner films and one of the two outer films are adhered to each other by means of hot sealing, the two inner films are side-attached to one of the two outer films while being compressed.

14. The method for manufacturing an air enclosure without a heat resistant material according to claim 11, wherein the heat resistant pad comprises a plurality of projecting portions, the projecting portions are placed between the two inner films, the two outer films and the two inner films are adhered to each other by means of hot sealing to form the plurality of air inlets.

15. The method for manufacturing an air enclosure without a heat resistant material according to claim 11, further comprising adhering the two outer films to each other by means of hot sealing to form a an air filling passageway at one side of the air cylinder, the air inlet communicating the air cylinder with the air filling passageway after the step of placing a heat resistant pad between the two inner films.

16. The method for manufacturing an air enclosure without a heat resistant material according to claim 15, further comprising using hot sealing to generating a plurality of hot sealing portions positioned in the air filling passageway and respectively adhering one sheet of the outer film to one sheet of the inner film after the step of adhering the tow outer films and the two inner films to each other by hot sealing to form at least one air inlet between the two inner films and at least one air cylinder between the two outer films.

17. The method for manufacturing an air enclosure without a heat resistant material according to claim 15, in which the step of filling air into the air cylinder to cause the air cylinder to be filled with air and expanded via the air inlet further comprises using the hot sealing portions to drive the two inner films to pull apart outward to open the air inlet when the two outer films are pulled apart outward.

18. The method for manufacturing an air enclosure without a heat resistant material according to claim 11, further comprising adhering the two outer films to each other by means of hot sealing to form an air filling passageway at one side of the air cylinder, the air inlet communicating the air cylinder with the air filling passageway after the step of placing a heat resistant pad between the two inner films.

19. The method for manufacturing an air enclosure without a heat resistant material according to claim 18, wherein the step of filling air into the air cylinder to cause the air cylinder to be filled with air and expanded via the air inlet further comprises driving the two inner films to pull apart outward to open the air inlet when the air filling passageway is filled with air and expanded.

20. The method for manufacturing an air enclosure without a heat resistant material according to claim 11, further comprising providing two auxiliary films to allow the two auxiliary films to be lain in between the two inner films after the step of providing two inner films.

21. The method for manufacturing an air enclosure without a heat resistant material according to claim 20, wherein the step of placing a heat resistant pad between the two inner films further comprises placing the heat resistant pad between the two auxiliary films.

22. The method for manufacturing an air enclosure without a heat resistant material according to claim 21, further comprising at least adhering the two inner film and the two auxiliary films to each other by means of hot sealing to form at least one auxiliary air inlet between the two auxiliary films after the step of placing the heat resistant pad between the two auxiliary films.
